(19) United States
(12) Patent Application Publication
(10) Pub. No.: US 2017/0214038 A1
(43) Pub. Date: Jul. 27, 2017

(54) LITHIUM TITANATE ELECTRODE MATERIAL, PRODUCING METHOD AND APPLICATIONS OF SAME

(71) Applicant: Ford Cheer International Limited, Tortola (VG)

(72) Inventor: Jianguo Xu, Pasadena, CA (US)

(21) Appl. No.: 15/408,561

(22) Filed: Jan. 18, 2017

Related U.S. Application Data
(60) Provisional application No. 62/286,617, filed on Jan. 25, 2016.

(51) Int. Cl. H01M 4/1391; H01M 4/133; C01G 23/00; H01M 4/04; H01M 10/0525; H01M 4/131; H01M 4/1393

(52) U.S. Cl. CPC H01M 4/1391; H01M 4/131; H01M 4/133; H01M 4/1393; H01M 4/0483; H01M 10/0525; H01M 4/0471; C01G 23/005; C01P 2006/40

(57) ABSTRACT

One aspect of the invention relates to a method for producing a lithium titanate electrode material including dispersing a nanocarbon material in a solvent to form a nanocarbon slurry; adding lithium and titanium compounds into the nanocarbon slurry at a desired mole ratio of lithium and titanium, and mixing them to form a precursor dispersion; spraying the precursor dispersion to form granulations so as to obtain precursor powders; and treating the precursor powders at a desired temperature for a period of time to produce a lithium titanate composite electrode material.

### CROSS-REFERENCE TO RELATED PATENT APPLICATION

This application claims priority to and the benefit of, pursuant to 35 U.S.C. §119(e), U.S. Provisional Patent Application Ser. No. 62/286,617, filed Jan. 25, 2016, which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD

The invention relates generally to nanomaterials, and more particularly to a lithium titanate electrode material, its preparation method and applications of the same.

### BACKGROUND

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

Conventionally, one of the main problems of lithium ion batteries is slow charging and poor safety performance. Compared to a graphite cathode, a lithium titanate cathode can obviously improve the charging time and safety performance of a lithium ion battery, which has great prospect of applications. However, the extremely low conductivity of a lithium titanate material leads to the poor conductive performance of lithium titanate, to some extent, becoming one of the bottlenecks of its applications.

To improve the conductivity of anode materials of lithium titanate, there are mainly three kinds of methods: the preparation of nano-lithium titanate, decreasing the particle size to shorten the lithium ion diffusion path, thus improving the electrical conductivity; doping; and carbon coating. Among them, the carbon coating technology is mainly performed by coating the conductive carbon layer on the surface of lithium titanate particles to improve the conductivity of the material.

Chinese Patent Publication No. CN102130324A discloses a preparation method of lithium titanate/carbon nanotube composite anode materials. The titanium compound is dissolved in anhydrous ethanol to form a first liquid. Lithium compounds are dissolved in deionized water, then adding carbon nanotubes and anhydrous ethanol, to form a second liquid. After mixing, a suitable amount of organic acids are added into the second liquid with continuous stiffing. The second liquid is added slowly into the first liquid under magnetic stirring, aged 1-12 hours, to form a third liquid. The third liquid is dried to be dry gel in the vacuum drying oven, then presintering 1-4 hours in 250-450° C. under nitrogen atmosphere, and sintering again 4-12 hours in 600-1200° C., after grinding of the product, lithium titanate/carbon nanotubes composite cathode materials are obtained. At the first 50 weeks, specific capacity of the material can reach 171 mAh·g⁻¹ in 0.1° C.

Chinese Patent Publication No. CN 102496707A discloses a preparation method of lithium titanate battery cathode material with nanocarbon coating spinel. The titanium dioxide and lithium are put into a dispersing agent, and calcined 2-36 hours at inert atmosphere with the temperature of 400-800° C., after naturally cooling to room temperature, the intermediate is obtained. The intermediate and carbon source are put into the dispersant, after drying, the mixture of intermediate product, carbon source and dispersant are calcined 2-36 hours under the second atmosphere with the temperature of 700-950° C., after natural cooling to room temperature, nanocarbon coated spinel lithium titanate are obtained.

Chinese Patent Publication No. CN102646810A discloses a preparation method of three-dimensional porous graphene doped with lithium titanate compound anode material, where three-dimensional porous graphene is dissolved in a solvent with 1-12 mg/mL solution, and lithium source and titanium source compounds are added under the condition of stirring, controlling the molar ratio of Li and Ti atoms between 0.7-0.9. The three-dimensional porous graphene and lithium titanate precursor sol gel are prepared firstly. Then, the three-dimensional porous graphene and lithium titanate precursor sol gel are dried under the temperature of 70-90° C. to get rid of the solvent, the three-dimensional porous graphene and lithium titanate precursor powder are obtained. Finally, the three-dimensional porous graphene and lithium titanate precursor powder are heated to 700-950° C. under inert gas protection for 8-20 hours, the three-dimensional porous graphene doped with lithium titanate composite materials are obtained, where the three-dimensional porous graphene is about 1-5% in weight.

However, the preparation process of carbon coated lithium titanate anode materials is complex and has poor performance for large-scale industrial production.

Therefore, a heretofore unaddressed need exists in the art to address the aforementioned deficiencies and inadequacies.

### SUMMARY

One of the objectives of this invention is to provide a simple preparation method of lithium titanate electrode composite materials that have small particle sizes and uniform particle morphology to improve the conductive performance of anode materials for lithium titanate, which is suitable for mass production.

In one aspect of the invention, a method for producing a lithium titanate electrode material includes dispersing a nanocarbon material in a solvent to form a nanocarbon slurry; adding lithium and titanium compounds into the nanocarbon slurry at a desired mole ratio of lithium and titanium, and mixing them to form a precursor dispersion; spraying the precursor dispersion to form granulations so as to obtain precursor powders; and treating the precursor powders at a desired temperature for a period of time to produce a lithium titanate composite electrode material.

In one embodiment, the desired mole ratio of lithium and titanium is about from 3.5:5 to 4.5:5.

In one embodiment, the desired temperature is about 800-900° C., and the period of time is about 1-10 hours.

In one embodiment, the nanocarbon material comprises carbon nanofibers, carbon nanotubes, carbon nanowires, carbon nanorods, carbon nanorings, graphene, or a combination thereof.

In one embodiment, the solvent comprises deionized water, N-methyl pyrrolidone, isopropyl alcohol, or a combination thereof.

In one embodiment, the nanocarbon slurry contains solid content of nanocarbon between about 1-5% in weight.

In one embodiment, the lithium compound comprises lithium hydroxide, lithium carbonate, lithium acetate, or the likes.

In one embodiment, the titanium compound comprises titanium dioxide, titanium chloride, tetrabutyl titanate, or the likes.

In one embodiment, the weight of lithium titanate in the lithium titanate composite electrode material is about 40-94%. In one embodiment, the weight of lithium titanate in the lithium titanate composite electrode material is about 80-94%.

In one embodiment, the dispersing step is performed with high-speed fluid shearing dispersion, with an optimized speed at about 5000-20000 r/min and an optimized time between about 5 minutes to about 2 hours.

In one embodiment, the spraying step is performed at a temperature of about 260-350° C.

In another aspect, the invention relate to a lithium titanate composite electrode material being made according to the above method. The lithium titanate composite electrode material has small particle sizes and uniform particle morphology, and has excellent properties in capacity and rate as well as good cycling stability. Accordingly, the lithium titanate/nanocarbon composite materials can enhance the loading of active materials, increasing the energy density of the electrodes.

In yet another aspect, the invention relate to a battery comprising an electrode made of the lithium titanate composite electrode material.

In one embodiment, the electrode is an anode electrode.

In one aspect, the invention relate to an article comprising the lithium titanate composite electrode material.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematic procedures for producing a lithium titanate composite material according to one embodiment of the invention.

FIG. 2 shows the SEM image of the lithium titanate composite material in Example 1 according to one embodiment of the present invention.

FIG. 3 shows the XRD graph of the lithium titanate composite material in Example 1 according to one embodiment of the present invention.

### DESCRIPTION OF EMBODIMENTS

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

The description is now made as to the embodiments of the invention in conjunction with the accompanying drawings. In accordance with the purposes of this invention, as embodied and broadly described herein, this invention relates to lithium titanate electrode composite materials that have small particle sizes and uniform particle morphology to improve the conductive performance of anode materials for lithium titanate, and the preparation method thereof. The preparation method of lithium titanate electrode composite materials is suitable for mass production.

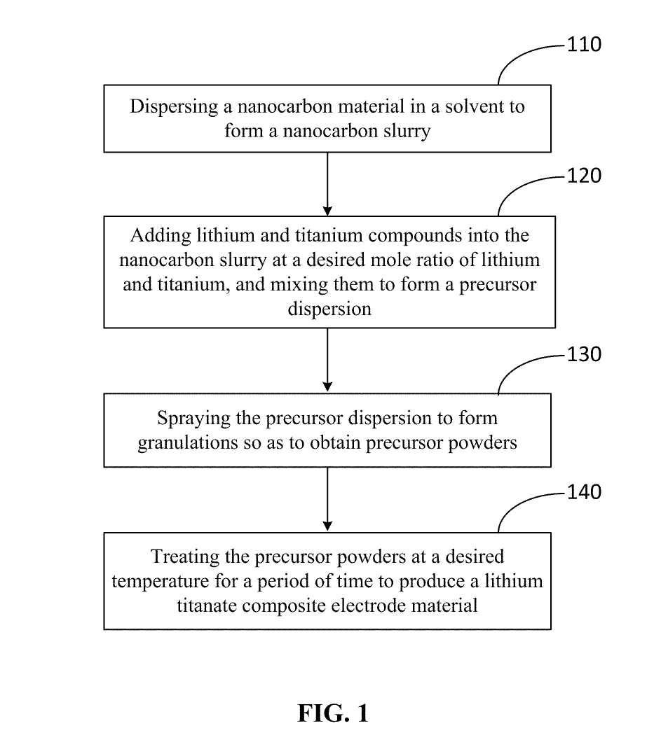

Referring to FIG. 1, a process chart for producing a lithium titanate electrode material is shown according to one embodiment of the invention. At step 110, a nanocarbon material is dispersed into a solvent to form a nanocarbon slurry. In one embodiment, the dispersing step is performed with high-speed fluid shearing dispersion, with an optimized speed at about 5000-20000 r/min and an optimized time between about 5 minutes to about 2 hours.

In one embodiment, the nanocarbon slurry contains solid content of nanocarbon between about 1-5% in weight.

In one embodiment, the nanocarbon material comprises carbon nanofibers, carbon nanotubes, carbon nanowires, carbon nanorods, carbon nanorings, graphene, or a combination thereof.

In one embodiment, the solvent comprises deionized water, N-methyl pyrrolidone, isopropyl alcohol, or a combination thereof.

At step 120, lithium and titanium compounds are added into the nanocarbon slurry at a desired mole ratio of lithium and titanium, and mixing them to form a precursor dispersion.

In one embodiment, the desired mole ratio of lithium and titanium is about from 3.5:5 to 4.5:5.

In one embodiment, the lithium compound comprises lithium hydroxide, lithium carbonate, lithium acetate, or the likes.

In one embodiment, the titanium compound comprises titanium dioxide, titanium chloride, tetrabutyl titanate, or the likes.

At step 130, the precursor dispersion is sprayed to form granulations so as to obtain precursor powders. In one embodiment, the spraying step is performed at a temperature of about 260-350° C.

At step 140, the precursor powders are treated at a desired temperature for a period of time to produce a lithium titanate composite electrode material. In one embodiment, the desired temperature is about 800-900° C., and the period of time is about 1-10 hours.

In one embodiment, the weight of lithium titanate in the lithium titanate composite electrode material is about 40-94%. In one embodiment, the weight of lithium titanate in the lithium titanate composite electrode material is about 80-94%.

Another aspect of the invention relate to a lithium titanate composite electrode material being made according to the above method. The lithium titanate composite electrode material has small particle sizes and uniform particle morphology, and has excellent properties in capacity and rate as well as good cycling stability. Accordingly, the lithium titanate/nanocarbon composite materials can enhance the loading of active materials, increasing the energy density of the electrodes.

In yet another aspect, the invention relate to a battery comprising an electrode made of the lithium titanate composite electrode material. In one embodiment, the electrode is an anode electrode.

In one aspect, the invention relate to an article comprising the lithium titanate composite electrode material.

Without intent to limit the scope of the invention, examples and their related results according to the embodiments of the present invention are given below.

### EXAMPLE 1

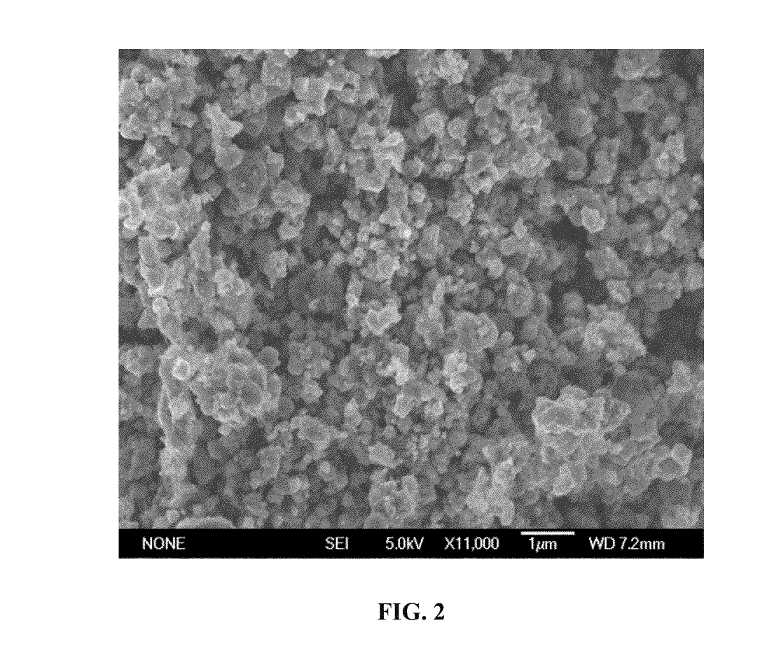

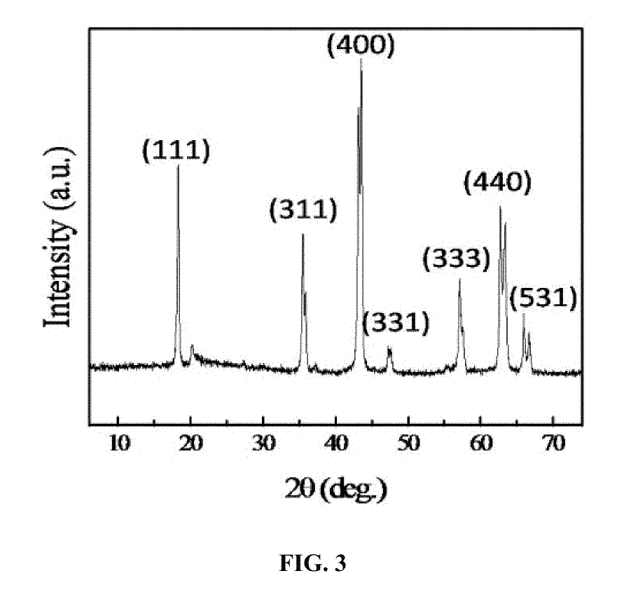

Firstly, carbon nanotubes are added into an isopropyl alcohol solvent, after high-speed fluid shearing dispersion at about 10000 rpm for about 30 minutes, a slurry with solid content of about 1% is obtained. Then a certain amount of lithium carbonate and tetrabutyltitanate with the mole ratio of about 4.2:5 are added into the slurry. After stirring at about 200 rpm for about 30 minutes, the uniform precursors are obtained. Then, the precursors are sprayed into the spray dryer under about 280° C. for granulation to precursor powders. Finally, the precursor powders are calcinated at about 800° C. for about 10 hours. After cooling, the modified lithium titanate composite material is obtained. The scanning electron microscope (SEM) image of the modified lithium titanate composite material is shown in FIG. 2, where the particles are clearly indicated, and fibrous carbon nanotubes can also be seen on the particles. Besides, the X-ray powder diffraction (XRD) characterization of the material further confirms the composition of the material is lithium titanate, as shown in FIG. 3.

The modified lithium titanate composite material is mixed with acetylene black and polyvinylidene fluoride (PVDF, 7 wt %) with the ratio of about 80:10:10 wt % to make the slurry. After coating the slurry on Cu foils, the electrodes were dried at about 105° C. in vacuum for about 6 hours to remove the solvent before pressing. Then the electrodes were cut into disks (13 mm in diameter) and dried at about 120° C. for about 12 hours in vacuum. Electrochemical measurements were carried out via CR2025 (3 V) coin-type cell with lithium metal as the counter/reference electrode, Celgard 2400 membrane separator, and 1 M LiPF₆ electrolyte solution dissolved in a mixture of ethylene carbonate (EC) and dimethyl carbonate (DMC) (EC/DMC, 1:1 v/v). The cells were assembled in an argon-filled glovebox. The results show that the modified lithium titanate composite anode materialexhibits excellent electrochemical performances. Specifically, the discharge capacities of the electrodes reach about 170 mAh g⁻⁴ at about 1 C and about 108 mAh g⁻¹ at about 10 C. Besides, the capacity retention is still up to about 98% after about 6000 charge-discharge cycles.

### EXAMPLE 2

The carbon nanotubes and carbon black are added into an isopropyl alcohol solvent with a weight ratio of 1:2. After high-speed fluid shearing dispersion at about 20000 rpm for about 5 minutes, a slurry with solid content of about 1% is obtained. Then a certain amount of lithium carbonate and titanium dioxide with the lithium mole ratio of about 3.5:5 are added into the slurry. After stirring at about 500 rpm for about 10 minutes, the uniform precursors are obtained. Then, the precursors are sprayed into the spray dryer under about 280 for granulation to precursor powders. Finally, the precursor powders are calcinated at about 800° C. for about 5 hours. After cooling, the modified lithium titanate composite materials are obtained.

The electrodes were prepared according to the similar procedures of Example 1. After charge-discharge tests at the same current, the results show that the modified lithium titanate composite anode material exhibits excellent electrochemical performances. Specifically, the discharge capacities of the electrodes reach about 158 mAh g⁻¹ at 1 C and about 84 mAh g⁻¹ at 10 C. Besides, the capacity retention is still up to about 99% after about 6000 charge-discharge cycles.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for producing a lithium titanate electrode material, comprising:
(a) dispersing a nanocarbon material in a solvent to form a nanocarbon slurry;
(b) adding lithium and titanium compounds into the nanocarbon slurry at a desired mole ratio of lithium and titanium, and mixing them to form a precursor dispersion;
(c) spraying the precursor dispersion to form granulations so as to obtain precursor powders; and
(d) treating the precursor powders at a desired temperature for a period of time to produce a lithium titanate composite electrode material.

2. The method according to the claim 1, wherein the desired mole ratio of lithium and titanium is about from 3.5:5 to 4.5:5.

3. The method according to the claim 1, wherein the desired temperature is about 800-900° C., and the period of time is about 1-10 hours.

4. The method according to the claim 1, wherein the nanocarbon material comprises carbon nanofibers, carbon nanotubes, carbon nanowires, carbon nanorods, carbon nanorings, graphene, or a combination thereof.

5. The method according to the claim 1, wherein the solvent comprises deionized water, N-methyl pyrrolidone, isopropyl alcohol, or a combination thereof.

6. The method according to the claim 1, wherein the nanocarbon slurry contains solid content of nanocarbon between about 1-5% in weight.

7. The method according to the claim 1, wherein the dispersing step is performed with high-speed fluid shearing dispersion, with an optimized speed at about 5000-20000 r/min and an optimized time between about 5 minutes to about 2 hours.

8. The method according to the claim 1, wherein the lithium compound comprises lithium hydroxide, lithium carbonate, lithium acetate, or the likes.

9. The method according to the claim 1, wherein the titanium compound comprises titanium dioxide, titanium chloride, tetrabutyl titanate, or the likes.

10. The method according to the claim 1, wherein the weight of lithium titanate in the lithium titanate composite electrode material is about 40-94%.

11. The method according to the claim 10, wherein the weight of lithium titanate in the lithium titanate composite electrode material is about 80-94%.

12. The method according to the claim 1, wherein the spraying step is performed at a temperature of about 260-350° C.

11. A lithium titanate composite electrode material, being made according to the method of claim 1.

12. A battery, comprising an electrode made of the lithium titanate composite electrode material of claim 11.

13. The battery according to the claim 12, wherein the electrode is an anode electrode.

14. An article, comprising the lithium titanate composite electrode material of claim 11.
